(19) United States
(12) Patent Application Publication
(10) Pub. No.: US 2008/0098072 A1
(43) Pub. Date: Apr. 24, 2008

(54) METHOD AND PROCESS TO ADD RECIPIENTS TO AN ON-GOING ELECTRONIC MESSAGE THREAD

(75) Inventors: Angela Richards Jones, Durham, NC (US); Ruthie D. Lyle, Durham, NC (US)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/551,920

(22) Filed: Oct. 23, 2006

(51) Int. Cl. G06F 15/16

(52) U.S. Cl. 709/206

(57) ABSTRACT

A method, article, and system to implement software for enabling recipients to be added to an electronic message thread, while providing for the new recipient to receive previous messages within the electronic message thread. In addition, members that are currently a part of the message thread are notified of the addition of a new member to the electronic message thread, when they send out a new message, in order to provide the existing member the option to include the new member as a recipient of the new message within the electronic message thread.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to electronic mail messaging, and more particularly to providing a method, article, and system for enabling a new member to be added to an electronic message thread, while providing for the new member to receive previous messages within the electronic message thread. In addition, members that are currently a part of the message thread are notified of the addition of a new member to the electronic message thread, when they send out a new message, in order to inform the existing member that a new member has been added to the electronic message thread and will receive their new outgoing message

2. Description of the Related Art

Electronic messages such as email have become a central feature of modern life and users have come to expect to receive electronic mail messages at any time and in virtually any place. For example, during the course of one day of travel, a user may receive electronic mail messages at a home desktop computer in the early morning, an office desktop computer in midmorning, via a cell phone or personal digital assistant in a taxi on the way to the airport, on a laptop computer via a wireless local area network while waiting in the airport lounge, via an in-flight telephone on the airplane, and in a hotel room via a high-speed Internet connection provided by the hotel at the end of the day.

The widespread proliferation and availability of electronic messaging has provided an efficient method to communicate information. In fact electronic messaging with its near instantaneous delivery from sender to receiver has made it the preferred method of business communication where hardcopy signatures are not required. In addition the ease of use and minimal cost of distribution has led to mass email to large distribution lists. The large distribution lists call often result in someone being inadvertently left off of the recipient list, or similarly there may be a need to add a recipient to the electronic message thread after several messages have already been sent. It's easy to add the missing person to the next electronic message sent on the thread, but when existing members start replying to the electronic messages that have been previously sent out, the new recipient will not receive the responses to the parts of the thread that they were not originally included on. Consequently, a large amount of the electronic messages communicated would never be sent to the new recipient and this presents an unavoidable gap in the flow of information.

The present invention is directed to addressing, or at least reducing, the effects of, one or more of the problems set forth above, by providing a method, article, and system for an extension of electronic message functionality by allowing the addition of addressable recipients in a message thread. The integrated functionality of the present invention is superior to the previous manual approach of adding a new member to an electronic message thread and much more robust. The original creator of the electronic message thread as well as recipients included in the electronic message thread itself will have the ability to add new recipients to a threaded electronic message conversation that is already in progress. An advantage to the solution of the present invention is that a recipient can be added at any point in the email thread, and still receive responses as if they had been on the thread from the very beginning.

### SUMMARY OF THE INVENTION

Embodiments of the present invention comprise a method for enabling recipients to be added to an electronic message thread. The method comprises a program for managing electronic message threads employed with user interfaces, and one or more servers. An originating sender initiates an electronic message thread to one or more recipients, and one or more recipients can be added to the electronic message thread utilizing the program via the user interface. The electronic message thread comprises a series of messages and replies between the originating sender and recipients, as well as between the recipients themselves; and the messages have similar subject matter and/or a common address list. Based on adding the additional recipients, the program creates meta-data with the one or more additional recipients and associates this meta-data to the electronic message thread that is stored on the message servers associated with the one or more recipients and the originating sender.

The information about the one or more additional recipients for the electronic message thread is persisted and aggregated by the present invention, which facilitates any recipient with access to the electronic message thread to open any electronic message in the electronic message thread and have the latest recipient updates, even if the updates were applied on a later or earlier part of the electronic message thread. The program of the present invention locates with retraction software previously sent electronic messages related to an electronic message thread stored on the message servers associated with the one or more recipients and the originating sender.

In response to the addition of one or more additional recipients to the message thread, the program of the present invention modifies the meta-data of the electronic messages that form the electronic message thread, wherein the meta-data is used to record changes in the recipient list, to record the identity of the one or more recipients or the originating sender that made the modifications, and to record the timing of the modifications.

The program of the present invention enables the additional recipients to gain access to information previously communicated in the electronic message thread before the additional recipients were added. Wherein the information is presented to the one or more additional recipients by a request from the additional recipients through their user interfaces. The requested information is presented in one or more of the following formats: a digest or archived version of all previous electronic messages in the electronic message thread in chronological order; a digest or archived version of all previous electronic messages in the electronic message thread in an order specified by the sender; and a copy of all previous electronic messages sent separately to the inbox of the one or more additional recipients in chronological order. The meta-data can also be employed to control access rights within the message thread. For Example, the originating sender and the one or more recipients can control access rights of the one or more additional recipients to add additional recipients to the message thread. The access rights are recorded in the meta-data associated with the one or more additional recipients

Recipients within the electronic message thread are notified by the program of the present invention of the addition of new recipients in the following manner; an icon near the address field on the user interface, wherein the icon expands when the one or more recipients hover over or clicks on the icon with an electronic pointer; and information attached to the end of the electronic message.

A system for implementing the method of the present invention, as well as, an article comprising one or more machine-readable storage media containing instructions that when executed enable a processor to carry out the method, are also provided.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1A and 1B are a series of diagrams illustrating the progression of an electronic message with multiple recipients according to an embodiment of the present invention.

FIG. 2 illustrates a system for practicing one or more embodiments of the present invention.

The detailed description explains the preferred embodiments of the invention, together with advantages and features, by way of example with reference to the drawings.

### DETAILED DESCRIPTION OF SPECIFIC EMBODIMENTS

Embodiments of the present invention provide a method, article, and system for enabling a new member to be added to an electronic message thread, while providing for the new member to receive previous messages within the electronic message thread. In addition, members that are currently a part of the message thread are notified of the addition of a new member to the electronic message thread, when they send out a new message, in order to provide the existing member the option to include the new member as a recipient of the new message within the electronic message thread.

The ability to add a new member to an electronic message thread is provided to the user through a graphical user interface (GUI) such as an “Add Recipient” option. The add recipient option allows the originator of an electronic message, or any of the recipients of an electronic message, to modify the addressable field of the electronic message thread. The fundamental infrastructure behind the GUI is one that allows the sender and any of the recipients of the email to locate email on the recipient's server. The present invention employs mail retraction applications that have traditionally been used for locating mail on a recipient's server after it has been sent. The retraction technology or other similar technologies are extended by the present invention to associate the meta-data containing the new recipients with the electronic message (i.e. add recipients to the message). The meta-data will also contain a record of modification (information related to a command to add recipients issued by a particular person) to be associated with the message.

Embodiments of the present invention allow a new recipient to be added at any point in the electronic message thread. When a new recipient is added to the thread, they will receive the current note in the thread, and optionally all of the information communicated in the thread before they were added. This information could be presented to the users, via a request from the user with a GUI interface in several ways including but not limited to:
A digest/archive version of all previous electronic messages in the thread sorted by chronological order
A digest/archive version of all previous electronic messages in the thread sorted by sender
A copy of all previous email sent separately to the requester's inbox in chronological order

The present invention utilizes meta-data that is linked to the electronic messages in the thread. The meta-data will include an updated recipient list, the identity of the person who made the changes, and information about when the change was made. When a recipient processes or reviews an electronic message entry in the thread, the associated meta-data is reviewed by the system to determine if any additional recipients are to be added to the addressable field. This meta-data is only displayed to a recipient when they process or review an electronic message entry in the thread. This information could be relayed to the user in several ways including but not limited to:
An icon near the addressable field that the user hovers above to get the information
a information attached to the end of the message as an extra addition
   All of the information about the new recipients for a particular thread is persisted and aggregated. This allows a recipient to open any email on the thread and have the latest recipient updates—even if the updates were applied on a later or earlier part of the electronic message thread.

The meta-data can also be employed to control access lights within the message thread. For Example, the originating sender and the one or more recipients can control access rights of the one or more additional recipients to add additional recipients to the message thread. The access rights are recorded in the meta-data associated with the one or more additional recipients.

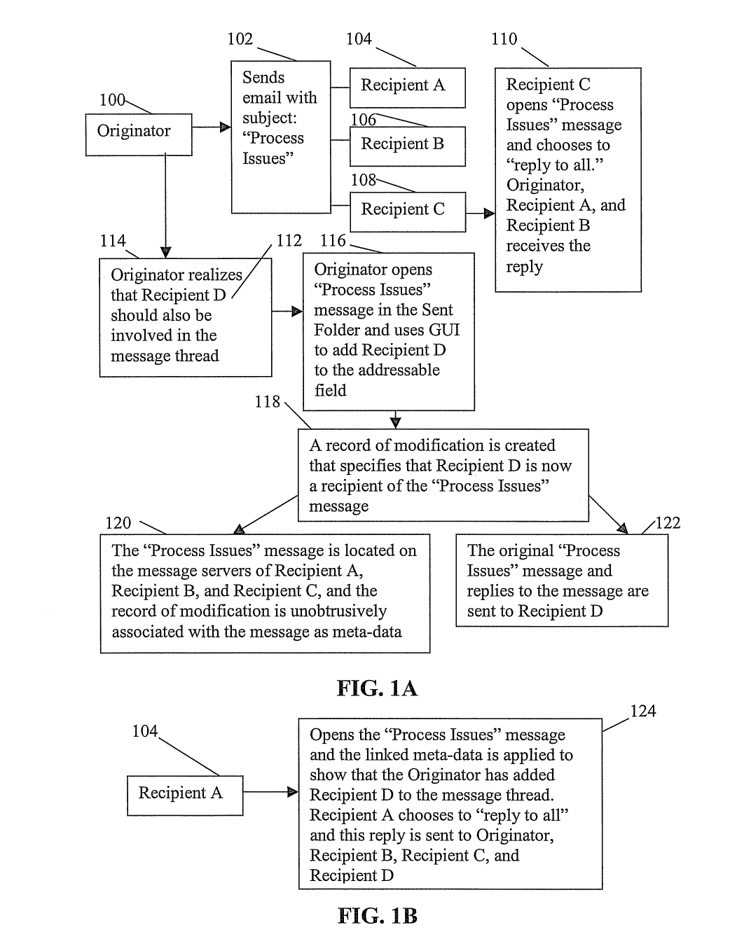

FIGS. 1A and 1B illustrate the progression of an electronic message with multiple recipients according to an embodiment of the present invention. In FIG. 1A an originating sender 100 sends a message 102 with a subject of “Process Issues” to three recipients (A, B, C) 104, 106, and 108. Upon receiving the “Process Issues” message, recipient C opens the message and chooses to “reply to all” with the originator 100, recipient A 104, and recipient B 106 receiving the reply. Subsequently, the originating sender 100 realizes 114 that recipient D 112 should also be involved in the message thread. The originating sender 100 opens the “Process Issues” email in the Sent Folder and uses a GUI to add recipient D 112 to the addressable field of the originating message (116). A record of modification to the address field of the original message is created 118 that specify that recipient D 112 is now a recipient of the “Process Issues” message. The “Process Issues” message is now located on the message servers associated with recipient A 104, recipient B 106, and recipient C 108 that has a record of the modification of the address field with the addition of recipient D 112 unobtrusively associated with the message as meta-data (120). The original “Process Issues” message and all replies to the message are sent to recipient D 112 (122).

In FIG. 1B recipient A 104 opens the “Process Issues” message with the modified meta-data indicating that recipient D 112 has been added. Recipient A 104 is notified through the GUI about the newly added recipient D 112. If recipient A 104 chooses to “reply to all,” the reply is sent to the originator 100, recipient B 106, recipient C 108, and recipient D 112.

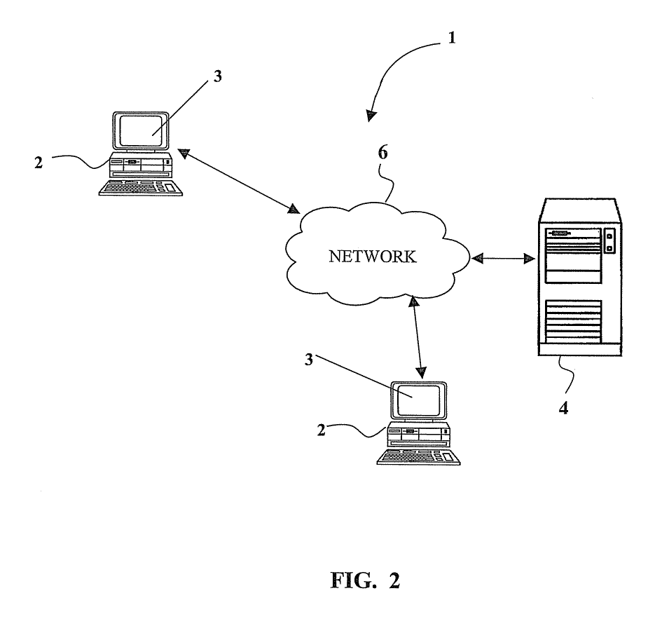

FIG. 2 is a block diagram of an exemplary system for implementing the message management of the present invention and graphically illustrates how those blocks interact in operation. The system includes one or more computing/communication devices 2 coupled to one or more servers 4 via a network 6. Each computing/communication device 2 may be implemented using a general-purpose computer executing a computer program for carrying out the processes described herein. The computing/communication devices 2 may also be, but are not limited to, portable computing devices, wireless devices, personal digital assistants (PDA), cellular devices, etc. The computer program may be resident on a storage medium local to the computing/communication devices 2, or maybe stored on the server system 4. The server system 4 may belong to a public service provider, or to an individual business entity or private party. The network 6 may be any type of known network including a local area network (LAN), wide area network (WAN), global network (e.g., Internet), intranet, wireless or cellular network, etc. The computing/communication devices 2 may be coupled to the server system 4 through multiple networks (e.g., intranet and Internet) so that not all computing/communication devices 2 are coupled to the server system 4 via the same network. In a preferred embodiment, the network 6 is a LAN and each computing/communication device 2 executes a user interface application (e.g., web browser) to contact the server system 4 through the network 6. Alternatively, a computing/communication device 2 may be implemented using a device programmed primarily for accessing network 6 such as a remote client. A display means 3 is provided for the user to interact with the message management program.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for enabling recipients to be added to an electronic message thread utilizing a program of instructions executable by a computer, wherein the method comprises:
sending an initial electronic message by an originating sender via a user interface to begin an electronic message thread to one or more recipients;
adding one or more additional recipients to the electronic message thread by the one or more recipients or the originating sender utilizing a user interface;
based on the adding, associating meta-data that when processed updates the address field, with the one or more additional recipients, with all electronic messages from the electronic message thread that are stored on message servers associated with the one or more recipients and the originating sender; and
wherein all information about the one or more additional recipients for the electronic message thread is persisted and aggregated, which facilitates any recipient with access to the electronic message thread to open any electronic message in the electronic message thread and have the latest recipient updates, even if the updates were applied on a later or earlier part of the electronic message thread.

2. The method of claim 1, wherein:
the sending in an electronic message thread comprises sending a series of messages and replies between the originating sender, the one or more recipients and the one or more additional recipients, and between the one or more recipients themselves, and between the one or more recipients and the one or more additional recipients; and
wherein the electronic messages have similar subject matter.

3. The method of claim 1, wherein:
the sending in an electronic message thread comprises sending a series of messages and replies between the originating sender, the one or more recipients and the one or more additional recipients, and between the one or more recipients themselves, and between the one or more recipients and the one or more additional recipients; and
wherein the electronic messages have common address lists.

4. The method of claim 1, wherein:
in response to the adding, locating, using retraction software, previously sent electronic messages related to an electronic message thread stored on the message servers associated with the one or more recipients and the originating sender.

5. The method of claim 1, wherein:
in response to the adding, modifying meta-data of the electronic messages that form the electronic message thread;
wherein the meta-data records the changes in the recipient list.

6. The method of claim 1, wherein:
in response to the adding, modifying meta-data of the electronic messages that form the electronic message thread;
wherein the meta-data is used to record the identity of the one or more recipients or the originating sender that made the modifications.

7. The method of claim 1, wherein:
in response to the adding, modifying meta-data of the electronic messages that form the electronic message thread;
wherein the meta-data is used to record the timing when the modifications were made.

8. The method of claim 1, wherein:
in response to the adding of one or more additional recipients, the additional recipients will receive the current electronic message in the electronic message thread.

9. The method of claim 1, wherein:
in response to the adding of one or more additional recipients, the additional recipients gain access to information previously communicated in the electronic message thread before the additional recipients were added;
wherein the information is presented to the one or more additional recipients by a request from the additional recipients through their user interfaces; and
wherein the information is presented in one or more of the following formats:
a digest or archived version of all previous electronic messages in the electronic message thread in chronological order;
a digest or archived version of all previous electronic messages in the electronic message thread in an order specified by the one or more additional recipients; and
a copy of all previous electronic messages sent separately to the inbox of the one or more additional recipients in chronological order.

10. The method of claim 1, wherein:
in response to the adding, the one or more recipients are notified of the one or more additional recipients when the one or more recipients opens an electronic message from the electronic message thread.

11. The method of claim 10, wherein:
the notification of the addition of the one or more additional recipients takes the form of at least one of the following:
an icon near the address field on the user interface, wherein the icon expands when the one or more recipients hover over or clicks on the icon with an electronic pointer; and
information attached to the end of the electronic message.

12. The method of claim 1, wherein:
the originating sender and the one or more recipients can control access rights of the one or more additional recipients to add additional recipients to the message thread; and
the access rights are recorded in the meta-data associated with the one or more additional recipients

13. An article comprising machine-readable storage media containing instructions that when executed by a processor enable the processor to manage electronic message threads in a system, wherein the system comprises computer servers, mainframe computers, and user interfaces, and wherein said computer servers and mainframe computers serve as message servers, and wherein said user interfaces further comprise desktop computers, laptop computers, mobile computing devices, and mobile communication devices and, the instructions for facilitating:
in response to an originating sender, initiating an electronic message thread to one or more recipients;
wherein one or more recipients or the originating sender can elect to add one or more additional recipients to the electronic message thread utilizing the instructions via the user interfaces; and
based on addition of the one or more additional recipients to associated meta-data, updating the address field, with the one or more additional recipients, of all electronic messages from the electronic message thread that are stored on the message servers associated with the one or more recipients and the originating sender; and
wherein all information about the one or more additional recipients for the electronic message thread is persisted and aggregated, which facilitates any recipient with access to the electronic message thread to open any electronic message in the electronic message thread and have the latest recipient updates, even if the updates were applied on a later or earlier part of the electronic message thread.

14. The article of claim 12, wherein:
the electronic message thread comprises a series of messages and replies between the originating sender and the recipients, as well as between the recipients themselves; and
wherein the electronic messages have similar subject matter.

15. The article of claim 12, wherein:
the electronic message thread comprises a series of messages and replies between the originating sender and the recipients, as well as between the recipients themselves; and
wherein the electronic messages have a common address lists.

16. The article of claim 12, wherein:
in response to the addition of the one or more additional recipients, the instructions locate with retraction software previously sent electronic messages related to an electronic message thread stored on the message servers associated with the one or more recipients and the originating sender;
wherein the meta-data including the one or more additional recipients is associated with the previously sent messages.

17. The article of claim 12, wherein:
the instructions notify the one or more recipients in response to the addition of the one or more additional recipients;
wherein the notification of the one or more recipients takes the form of at least one of the following:
an icon near the address field on the user interface, wherein the icon expands when the one or more recipients hover over or clicks on the icon with an electronic pointer; and
information attached to the end of the electronic message.

18. The article of claim 12, wherein:
the instructions, in response to the addition of the one or more additional recipients, modifies the meta-data of the electronic messages that form the electronic message thread; wherein the modifications facilitated by the instructions comprises at least one of the following:
the meta-data records the changes in the recipient list;
the meta-data is used to record the identity of the one or more recipients or the originating sender that made the modifications; and
the meta-data is used to record the timing when the modifications were made.

19. The article of claim 12, wherein:
the instructions, in response to the addition of the one or more additional recipients, facilitate the one or more additional recipients to gain access to information previously communicated in the electronic message thread before the one or more additional recipients were added;
wherein the information is presented to the one or more additional recipients by a request from the additional recipients through their user interfaces; and
wherein the information is presented in one or more of the following formats:
a digest or archived version of all previous electronic messages in the electronic message thread in chronological order;
a digest or archived version of all previous electronic messages in the electronic message thread in an order specified by the one or more additional recipients; and
a copy of all previous electronic messages sent separately to the inbox of the one or more additional recipients in chronological order.

20. A system for managing electronic message threads and enabling additional recipients to be added to a message thread,
wherein the system comprises computing devices and a network;
wherein the computing devices further comprise at least one of the following:
computer servers;
mainframe computers;
desktop computers; and
mobile computing devices; and
wherein at least one of the computing devices is configured to execute electronic software that manages the electronic message threads; and
wherein the electronic software is resident on a storage medium in signal communication with at least one of the computing devices; and
wherein at least one of the computing devices is in signal communication with the network; and
wherein the network further comprises at least one of the following:
local area network (LAN);
wide area network (WAN);
a global network;
the Internet;
an intranet;
wireless networks; and
cellular networks; and
wherein based on the additional recipients, the electronic software updates the address field, with the one or more additional recipients, of all electronic messages from the electronic message thread that are stored on the computing devices associated with one or more recipients and an originating sender of the electronic message thread; and
wherein all information about the one or more additional recipients for the electronic message thread is persisted and aggregated, which facilitates any recipient with access to the electronic message thread to open any electronic message in the electronic message thread and have the latest recipient updates, even if the updates were applied on a later or earlier part of the electronic message thread; and
wherein the one or more recipients and the originating sender are notified of the addition of one or more additional recipients.
